(19) United States
(12) Patent Application Publication
(10) Pub. No.: US 2022/0343253 A1
(43) Pub. Date: Oct. 27, 2022

(54) Virtual Coaching System

(71) Applicant: STATS LLC, Chicago, IL (US)

(72) Inventors: Patrick Joseph Lucey, Chicago, IL (US); Christian Marko, Graz (AT); Hector Ruiz, Barcelona (ES); Paul David Power, Leeds (GB)

(73) Assignee: STATS LLC, Chicago, IL (US)

(21) Appl. No.: 17/660,971

(22) Filed: Apr. 27, 2022

Related U.S. Application Data
(60) Provisional application No. 63/180,165, filed on Apr. 27, 2021.

(51) Int. Cl. G06Q 10/06; G06N 3/04

(52) U.S. Cl. CPC G06Q 10/06375; G06Q 10/063118; G06Q 10/06398; G06N 3/0454

(57) ABSTRACT

A computing system receives a pre-game lineup against a target opponent. The pre-game lineup includes a representation of each player starting a game against the target opponent. The computing system retrieves a first set of historical data for each player in the pre-game lineup and team-specific information. The computing system retrieves a second set of historical data for each player of the target opponent and target opponent-specific information. The computing system predicts an outcome for the game based on the first set of historical data and the second set of historical data. The computing system projects a future effect of the pre-game lineup on at least one season of play by simulating team and player performance. The computing system generates a graphical output reflecting the predicted outcome of the game and the simulation of team and player performance over the at least one season of play.

### CROSS-REFERENCE TO RELATED APPLICATIONS

This application claims priority to U.S. Provisional Application Ser. No. 63/180,165, filed Apr. 27, 2021, which is hereby incorporated by reference in its entirety.

### FIELD OF THE DISCLOSURE

The present disclosure generally relates to system and method for generating a predictive model and, more specifically, a system and method for predicting pre-match and in-match outcomes for assisting a coach.

### BACKGROUND

In professional sports, there is a tradeoff between short-term and long-term benefits where coaches and/or general managers are forced to choose between winning today versus being successful long-term. When coaches play the long game, they are often criticized, as the pressure to winning now and/or playing the star player every night is at odds with the long-term health and output of a player.

### SUMMARY

In some embodiments, a method is disclosed herein. A computing system receives a pre-game lineup against a target opponent. The pre-game lineup includes a representation of each player starting a game against the target opponent. The computing system retrieves a first set of historical data for each player in the pre-game lineup and team-specific information. The computing system retrieves a second set of historical data for each player of the target opponent and target opponent-specific information. The computing system predicts an outcome for the game based on the first set of historical data and the second set of historical data. The computing system projects a future effect of the pre-game lineup on at least one season of play by simulating team and player performance. The computing system generates a graphical output reflecting the predicted outcome of the game and the simulation of team and player performance over the at least one season of play.

In some embodiments, a method is disclosed herein. A computing system receives event data corresponding to a game currently underway. The event data includes real-time tracking data of each player on a target team and each player on a target opponent. The computing system determines that a player of the target team is underperforming compared to a projected performance. The computing system generates an alert or recommendation for a coach of the target team upon determining that the player of the target team is underperforming.

In some embodiments, a system is disclosed herein. The system includes a processor and a memory. The memory has programming instructions stored thereon, which, when executed by the processor, causes the system to perform operations. The operations include receiving a pre-game lineup of a team against a target opponent. The pre-game lineup includes a representation of each player starting a game against the target opponent. The operations further include retrieving a first set of historical data for each player in the pre-game lineup and team-specific information. The operations further include retrieving a second set of historical data for each player of the target opponent and target opponent-specific information. The operations further include predicting an outcome for the game based on the first set of historical data and the second set of historical data. The operations further include projecting a future effect of the pre-game lineup on at least one season of play by simulating team and player performance. The operations further include generating a graphical output reflecting the predicted outcome of the game and the simulation of team and player performance over the at least one season of play.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a flow diagram illustrating a method of generating a pre-game recommendation to an actual coach, according to example embodiments.

FIG. 3 is a flow diagram illustrating a method of generating a live game recommendation to an actual coach, according to example embodiments.

FIG. 4 illustrates an example graphical user interface according to example embodiments.

FIG. 5A is a block diagram illustrating a computing device, according to example embodiments.

FIG. 5B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

One or more techniques described herein provides a virtual coach configured to recommend to an actual coach both pre-game and intra-game suggestions for the actual coach to implement. The proposed suggestions may be such that they not only optimize the likelihood of the team winning the current match, but also optimize the season outcome, as well as the health of each player on the team. To generate such predictions, the present approach may utilize a combination of short-term micro predictions to forecast outputs within the current match, as well as macro predictions, which optimize for the long-term benefits of the team, as well as players on the team.

Use of the virtual coach may help both coaches and general managers at many levels. For example, the virtual coach may aid the coach and/or general manager to build a team, which may have the biggest impact at the end or the regular season and not merely focused on a single game. The impact may be felt not only on the end of the season standings, but also on team and player statistics. In another example, the virtual coach may aid the coach and/or general manager with-in-game decisions by identifying those players that are struggling and determining which replacement player would impact the game. In another example, the virtual coach may assist coaches and/or general managers regarding the transferring or trading of players in and out of the team.

Further, the utilization of such technology may not only be useful for coaches and general managers of teams, but may also be used by league offices (e.g., NBA, English Premier League, etc.) to officiate whether resting a player is appropriate or not.

While the present discussion is provided in the context of both soccer and basketball, those skilled in the art readily understand that such functionality may be extended to other sports.

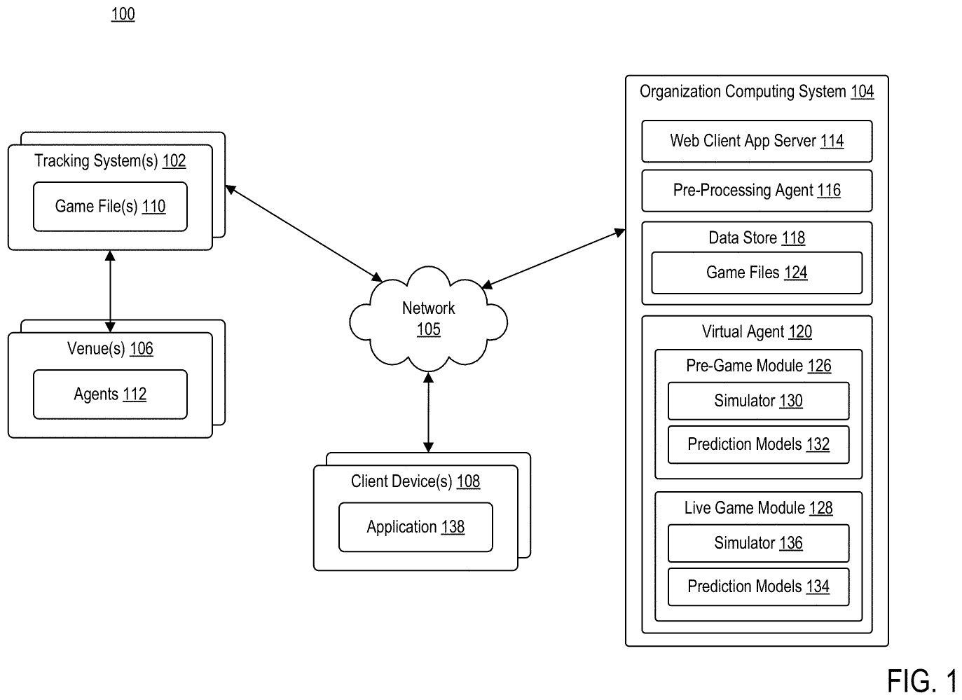

FIG. 1 is a block diagram illustrating a computing environment 100, according to example embodiments. Computing environment 100 may include tracking system 102, organization computing system 104, and one or more client devices 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106. For example, venue 106 may be configured to host a sporting event that includes one or more agents 112. Tracking system 102 may be configured to record the motions of all agents (i.e., players) on the playing surface, as well as one or more other objects of relevance (e.g., ball, referees, etc.). In some embodiments, tracking system 102 may be an optically-based system using, for example, a plurality of fixed cameras. For example, a system of six stationary, calibrated cameras, which project the three-dimensional locations of players and the ball onto a two-dimensional overhead view of the court may be used. In some embodiments, tracking system 102 may be a radio-based system using, for example, radio frequency identification (RFID) tags worn by players or embedded in objects to be tracked. Generally, tracking system 102 may be configured to sample and record, at a high frame rate (e.g., 25 Hz). Tracking system 102 may be configured to store at least player identity and positional information (e.g., (x, y) position) for all agents and objects on the playing surface for each frame in a game file 110.

Game file 110 may be augmented with other event information corresponding to event data, such as, but not limited to, game event information (pass, made shot, turnover, etc.) and context information (current score, time remaining, etc.).

Tracking system 102 may be configured to communicate with organization computing system 104 via network 105. Organization computing system 104 may be configured to manage and analyze the data captured by tracking system 102. Organization computing system 104 may include at least a web client application server 114, a pre-processing agent 116, a data store 118, and a virtual agent 120. Each of pre-processing agent 116 and virtual agent 120 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Data store 118 may be configured to store one or more game files 124. Each game file 124 may include spatial event data and non-spatial event data. For example, spatial event data may correspond to raw data captured from a particular game or event by tracking system 102. Non-spatial event data may correspond to one or more variables describing the events occurring in a particular match without associated spatial information. For example, non-spatial event data may correspond to each play-by-play event in a particular match. In some embodiments, non-spatial event data may be derived from spatial event data. For example, pre-processing agent 116 may be configured to parse the spatial event data to derive play-by-play information. In some embodiments, non-spatial event data may be derived independently from spatial event data. For example, an administrator or entity associated with organization computing system may analyze each match to generate such non-spatial event data. As such, for purposes of this application, event data may correspond to spatial event data and non-spatial event data.

In some embodiments, each game file 124 may further include the home and away team box scores. For example, the home and away teams' box scores may include the number of team assists, fouls, rebounds (e.g., offensive, defensive, total), steals, and turnovers at each time, t, during gameplay. In some embodiments, each game file 124 may further include a player box score. For example, the player box score may include the number of player assists, fouls, rebounds, shot attempts, points, free-throw attempts, free-throws made, blocks, turnovers, minutes played, plus/minus metric, game started, and the like. Although the above metrics are discussed with respect to basketball, those skilled in the art readily understand that the specific metrics may change based on sport. For example, in soccer, the home and away teams' box scores may include shot attempts, assists, crosses, shots, and the like.

Pre-processing agent 116 may be configured to process data retrieved from data store 118. For example, pre-processing agent 116 may be configured to generate one or more sets of information that may be used to train virtual agent 120.

Virtual agent 120 may be configured to generate one or more recommendations to an actual coach both before and during a game regarding a team's lineup. Virtual agent 120 may include a pre-game module 126 and a live game module 128.

Pre-game module 126 may be configured to predict the likelihood of winning a current game prior to initiation of the game. For example, pre-game module 126 may be configured to generate both team statistics and player statistics for an upcoming game for a defined team line-up against a specified opponent. Pre-game module 126 may include one or more prediction models 132.

One or more prediction models 132 may be representative of a match prediction agent, such as that disclosed in U.S. application Ser. No. 16/254,088, entitled “Method and System for Interactive, Interpretable, and Improved Match and Player Performance in Team Sports.” Such prediction models 132 may assist virtual agent 120 in generating pre-match predictions for a current match. For example, one or more prediction models 132 may be trained to predict an outcome of a game, prior to initiation of the game. At a high-level, one or more prediction models 132 may be configured to predict an outcome of a match based on, for example, a proposed starting lineup of the game and the target opponent. For example, in some embodiments, one or more prediction models 132 may generate a pre-match prediction based on one or more of team strength (pre-game odds), opposition strength (pre-game odds), which team is home vs. away (e.g., is_home_flag), which players are starting the game on one team or both teams (e.g., is_starter_flag), a role or position of each player, recent team play outcomes (e.g., the last 5 games), recent opponent play (e.g., the last 5 games), or recent player play (e.g., the last 5 games). In some embodiments, each of these metrics may correspond to its own unique neural network.

Pre-game module 126 may further include a simulator 130. Using the team statistics and player statistics, simulator 130 may predict the impact of the present line-up on the final season standings and statistics. In this manner, pre-game module 126 may provide an actual coach with recommendations regarding which players would be best to pick for an upcoming game to optimize for both short-term and long-term results.

In some embodiments, pre-game module 126 may further take into consideration potential trades or transfer recommendations. For example, in the pre-game planning stage, pre-game module 126 may recommend trading for or transferring a player. Pre-game module 126 may illustrate the potential trade or transfer asset's impact in both the upcoming game (e.g., using one or more prediction models 132) and/or across a season or seasons (e.g., using simulator 130). Such functionality may be particularly useful at trade deadlines, where teams can estimate both short term and long term impacts of a trade or transfer.

Live game module 128 may be configured to provide recommendations to an actual coach based on live game data. For example, once a lineup has been selected (e.g., based on suggestions provided by pre-game module 126), live game module 128 may leverage live data (e.g., both event data and/or tracking data) to monitor team and player performance. Based on the monitoring, live game module 128 may alert the actual coach as to which player or players are under-performing. Live game module 128 may include one or more prediction models 134. One or more prediction models 134 may be representative of a live game module of a match prediction agent, such as that disclosed in U.S. application Ser. No. 16/254,088, entitled “Method and System for Interactive, Interpretable, and Improved Match and Player Performance in Team Sports.”

One or more prediction models 134 may be configured to predict an outcome of a match, after initiation of the match. For example, one or more prediction models 134 may be configured to predict the outcome of the match during any point within the match. One or more prediction models 134 may be able to predict the outcome of a match based on, for example, current game context (e.g., which players are on the field, in game team states, in game player stats), team history, and/or agent history.

In some embodiments, the actual coach may provide input to live game module 128 regarding a proposed substitution. Using one or more prediction models 134, live game module 128 may generate the predicted difference in output between the current player and the proposed substitution. In some embodiments, the coach can propose several player substitutions for a current player to determine which proposed substitution would yield the greatest improvement in output.

Live game module 128 may further include a simulator 136. Using the team statistics and player statistics, simulator 136 may predict the impact of the proposed substitution on the final season standings and statistics. In this manner, live game module 128 may provide an actual coach with recommendations regarding which players would be best to substitute within an ongoing game to optimize for both short-term and long-term results.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 138. Application 138 may be representative of a web browser that allows access to a website or a stand-alone application. Client device 108 may access application 138 to access one or more functionalities of organization computing system 104. Client device 108 may communicate over network 105 to request a webpage, for example, from web client application server 114 of organization computing system 104. For example, client device 108 may be configured to execute application 138 to view one or more recommendations or alerts generated by virtual agent 120 and/or propose a substitution within a game for further analysis by virtual agent 120.

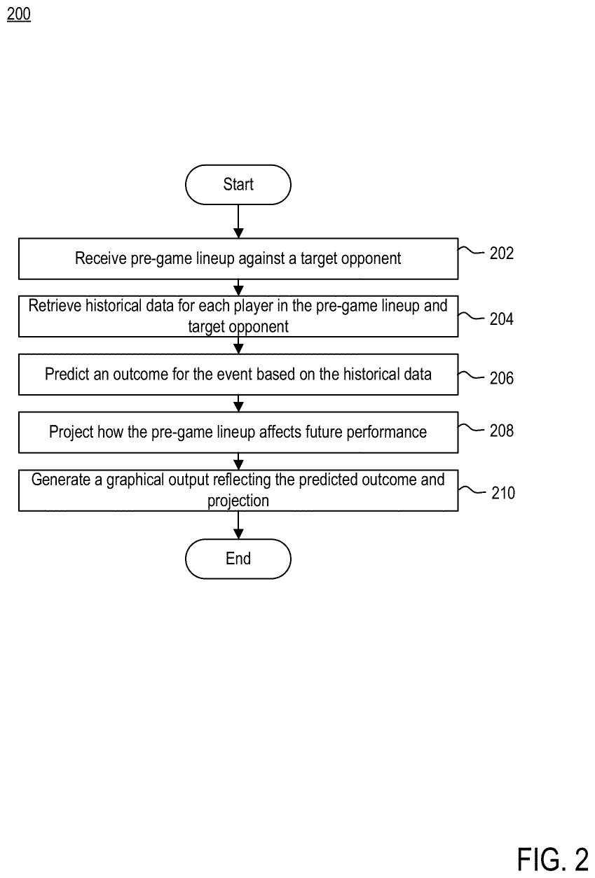

FIG. 2 is a flow diagram illustrating a method 200 of generating a pre-game recommendation to an actual coach, according to example embodiments. Method 200 may begin at step 202.

At step 202, organization computing system 104 may receive a pre-game lineup against a target opponent. The pre-game lineup may include representation of each player in a “starting lineup.” A starting lineup is a lineup or group of players that starts a game. In some embodiments, organization computing system 104 may receive the pre-game lineup from a user of client device 108 via application 138 executing thereon. For example, a coach of the team may select players off the roster to add to a potential starting lineup.

At step 204, in response to receiving the pre-game lineup, organization computing system 104 may retrieve historical data for each player in the pre-game lineup and each player of the opposing team. For example, virtual agent 120 may gather team-specific information and agent specific information for each player in the proposed pre-game lineup and team-specific information and agent specific information for each player of the opposing team.

At step 206, organization computing system 104 may predict an outcome for the event based on the historical data for each player in the pre-game lineup and each player of the opposing team. For example, pre-game module 126 may utilize one or more prediction models 132 to predict the outcome of the event based on the information provided by the coach or user.

At step 208, organization computing system 104 may project how the lineup affects future performance of each player on the team and the overall team. For example, pre-game module 126 may utilize simulator 130 to simulate both player performance and team performance over the course of at least one season based on the proposed pre-match lineup.

At step 210, organization computing system 104 may generate a graphical output reflecting the predicted outcome of the current match and the simulation of player and team performance over the course of at least one season.

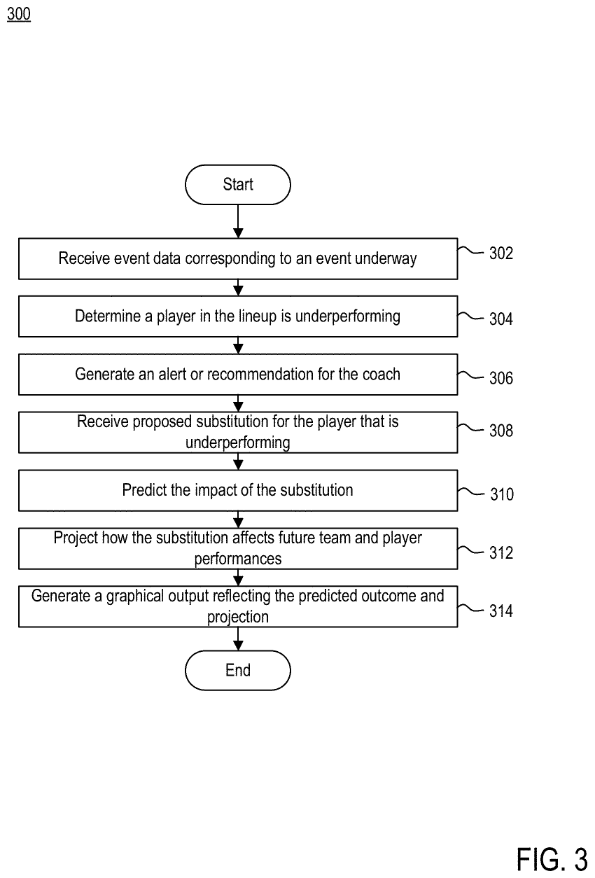

FIG. 3 is a flow diagram illustrating a method 300 of generating a live game recommendation to an actual coach, according to example embodiments. Method 300 may begin at step 302.

At step 302, organization computing system 104 may receive event data corresponding to the event or game currently underway. For example, virtual agent 120 may receive, from tracking system 102, in real-time, near real-time, or periodically one or more sets of event data of a match currently in progress. In some embodiments, virtual agent 120 may receive, from one or more computing systems, in real-time, near real-time, or periodically one or more sets of event data derived from an entity associated with organization computing system 104. Such event data may include one or more features of match play (e.g., play-by-play events).

At step 304, organization computing system 104 may determine that a player in the lineup is underperforming compared to their project performance. For example, virtual agent 120 may leverage the one or more sets of event data of the match currently in progress to determine whether a player currently in the game is underperforming. To do so, virtual agent 120 may leverage one or more prediction models 132 of live game module 128 to project player performance within the game.

At step 306, organization computing system 104 may generate an alert or recommendation for the coach based on determining that the player in the lineup is underperforming. For example, virtual agent 120 may generate a notification (e.g., a push notification) to be provided to the coach or user via application 138 executing on client device 108.

At step 308, organization computing system 104 may receive a proposed substitution for the player that is underperforming. For example, organization computing system 104 may receive the proposed substitution via application 138 executing on client device 108.

At step 310, organization computing system 104 may predict the impact of the substitution based on historical player information. For example, live game module 128 may generate a predicted outcome of the match based on the historical player information and the current game context using one or more prediction models 132.

At step 312, organization computing system 104 may project how the substitution impacts the team and the player long term. For example, virtual agent 120 may leverage simulator 136 of live game module 128 to simulate or project how the proposed substitution may affect the team and/or player long term.

At step 314, organization computing system 104 may generate a graphical output reflecting the projected output of the game with the player currently underperforming compared to the proposed substitution. In some embodiments, virtual agent 120 may provide multiple graphical representations multiple proposed substitutions and how they compare to a player currently underperforming.

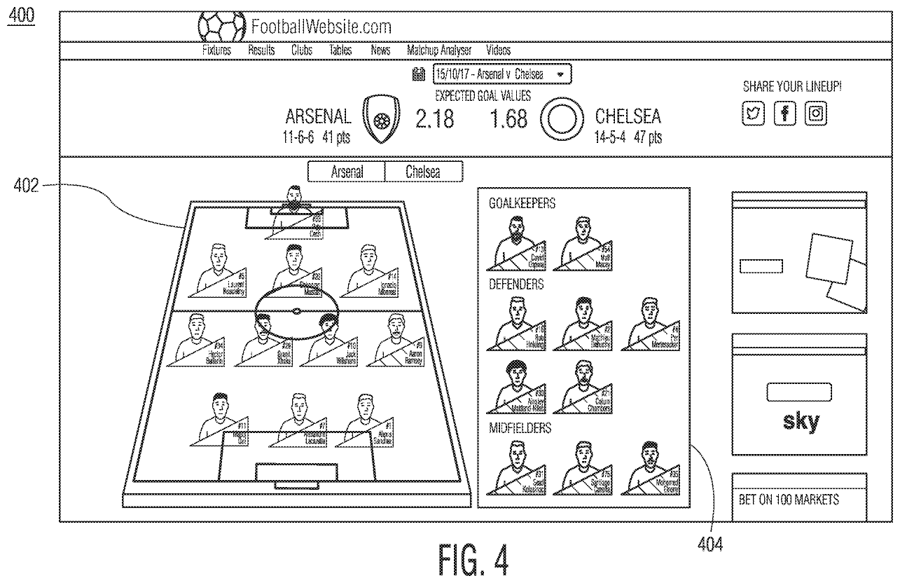

FIG. 4 illustrates an example graphical user interface 400 according to example embodiments. As shown, graphical user interface 400 may correspond to a pre-match lineup and projected match result based on the currently selected pre-match lineup.

As shown in FIG. 4, GUI 400 may include first section 402 and a second section 404. First section 402 may visually depict a first set of players on the team that are currently set to start the game or are currently in the game. Second section 404 may visually depict a second set of players on the team that are currently not set to start the game (i.e., reserves) or are currently not in the game. Via GUI 400, a user, such as a coach, may replace one of the players in the first set of players with one of the players in the second set of players. Responsive to the input, virtual agent 120 may generate a proposed outcome for the match.

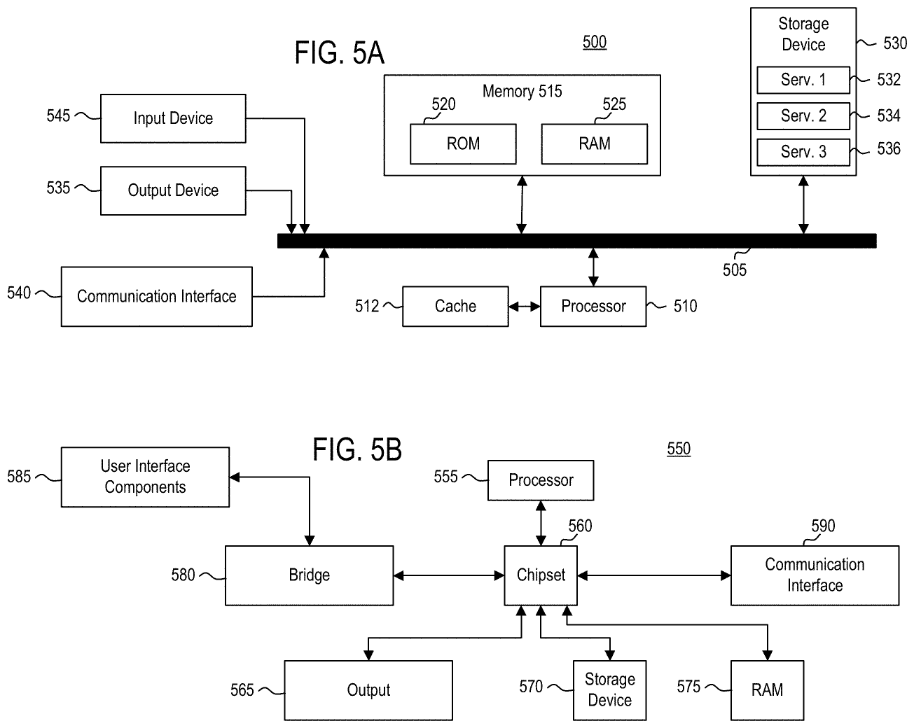

FIG. 5A illustrates a system bus architecture of computing system 500, according to example embodiments. System 500 may be representative of at least a portion of organization computing system 104. One or more components of system 500 may be in electrical communication with each other using a bus 505. System 500 may include a processing unit (CPU or processor) 510 and a system bus 505 that couples various system components including the system memory 515, such as read only memory (ROM) 520 and random access memory (RAM) 525, to processor 510. System 500 may include a cache of high-speed memory connected directly with, in close proximity to, or integrated as part of processor 510. System 500 may copy data from memory 515 and/or storage device 530 to cache 512 for quick access by processor 510. In this way, cache 512 may provide a performance boost that avoids processor 510 delays while waiting for data. These and other modules may control or be configured to control processor 510 to perform various actions. Other system memory 515 may be available for use as well. Memory 515 may include multiple different types of memory with different performance characteristics. Processor 510 may include any general purpose processor and a hardware module or software module, such as service 1 532, service 2 534, and service 3 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction with the computing system 500, an input device 545 may represent any number of input mechanisms, such as a microphone for speech, a touch-sensitive screen for gesture or graphical input, keyboard, mouse, motion input, speech and so forth. An output device 535 may also be one or more of a number of output mechanisms known to those of skill in the art. In some instances, multimodal systems may enable a user to provide multiple types of input to communicate with computing system 500. Communications interface 540 may generally govern and manage the user input and system output. There is no restriction on operating on any particular hardware arrangement and therefore the basic features here may easily be substituted for improved hardware or firmware arrangements as they are developed.

Storage device 530 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 525, read only memory (ROM) 520, and hybrids thereof.

Storage device 530 may include services 532, 534, and 536 for controlling the processor 510. Other hardware or software modules are contemplated. Storage device 530 may be connected to system bus 505. In one aspect, a hardware module that performs a particular function may include the software component stored in a computer-readable medium in connection with the necessary hardware components, such as processor 510, bus 505, output device 535 (e.g., display), and so forth, to carry out the function.

FIG. 5B illustrates a computer system 550 having a chipset architecture that may represent at least a portion of organization computing system 104. Computer system 550 may be an example of computer hardware, software, and firmware that may be used to implement the disclosed technology. System 550 may include a processor 555, representative of any number of physically and/or logically distinct resources capable of executing software, firmware, and hardware configured to perform identified computations. Processor 555 may communicate with a chipset 560 that may control input to and output from processor 555. In this example, chipset 560 outputs information to output 565, such as a display, and may read and write information to storage device 570, which may include magnetic media, and solid state media, for example. Chipset 560 may also read data from and write data to storage device 575 (e.g., RAM). A bridge 580 for interfacing with a variety of user interface components 585 may be provided for interfacing with chipset 560. Such user interface components 585 may include a keyboard, a microphone, touch detection and processing circuitry, a pointing device, such as a mouse, and so on. In general, inputs to system 550 may come from any of a variety of sources, machine generated and/or human generated.

Chipset 560 may also interface with one or more communication interfaces 590 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 555 analyzing data stored in storage device 570 or storage device 575. Further, the machine may receive inputs from a user through user interface components 585 and execute appropriate functions, such as browsing functions by interpreting these inputs using processor 555.

It may be appreciated that example systems 500 and 550 may have more than one processor 510 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is Claimed:

1. A method, comprising:
receiving, by a computing system, a pre-game lineup of a team against a target opponent, wherein the pre-game lineup includes a representation of each player starting a game against the target opponent;
retrieving, by the computing system, a first set of historical data for each player in the pre-game lineup and team-specific information;
retrieving, by the computing system, a second set of historical data for each player of the target opponent and target opponent-specific information;
predicting, by the computing system, an outcome for the game based on the first set of historical data and the second set of historical data;
projecting, by the computing system, a future effect of the pre-game lineup on at least one season of play by simulating team and player performance; and
generating, by the computing system, a graphical output reflecting the predicted outcome of the game and the simulation of team and player performance over the at least one season of play.

2. The method of claim 1, further comprising:
receiving, by the computing system, a trade proposal, wherein the trade proposal comprises adding a target player to the team;
retrieving, by the computing system, a third set of historical data for the target player;
injecting, by the computing system, the target player in the pre-game lineup;
predicting, by the computing system, an updated outcome for the game based on the first set of historical data, the second set of historical data, and the third set of historical data; and
projecting, by the computing system, an updated future effect of the pre-game lineup with the target player on at least one season of play by simulating team and player performance.

3. The method of claim 2, further comprising:
generating, by the computing system, an updated graphical output reflecting the updated predicted outcome of the game and the updated simulation of team and player performance over the at least one season of play.

4. The method of claim 1, wherein predicting, by the computing system, the outcome for the game based on the first set of historical data and the second set of historical data comprises:
generating a team strength metric for the team using a first neural network; and
generating a second team strength metric for the target opponent using a second neural network.

5. The method of claim 4, wherein predicting, by the computing system, the outcome for the game based on the first set of historical data and the second set of historical data comprises:
generating role information for each player in the pre-game lineup, using a third neural network, based on the first set of historical data.

6. The method of claim 5, wherein predicting, by the computing system, the outcome for the game based on the first set of historical data and the second set of historical data comprises:
identifying recent performance data of the team, a second set of recent performance data of the target opponent, and third set of recent performance data of each player of the team and each player of the target opponent.

7. The method of claim 6, wherein predicting, by the computing system, the outcome for the game based on the first set of historical data and the second set of historical data comprises:
predicting the outcome for the game based on one or more of the team strength metric, the second team strength metric, the role information, the recent performance data, the second set of recent performance data, or the third set of recent performance data.

8. A method comprising:
receiving, by a computing system, event data corresponding to a game currently underway, the event data comprising real-time tracking data of each player on a target team and each player on a target opponent;
determining, by the computing system, that a player of the target team is underperforming compared to a projected performance; and
generating, by the computing system, an alert or recommendation for a coach of the target team upon determining that the player of the target team is underperforming.

9. The method of claim 8, further comprising:
proposing, by the computing system, a substitution for the player by projecting future performance of the target team in the game with the proposed substitution for the player.

10. The method of claim 8, further comprising:
receiving, by the computing system from a client device, a proposed substitution for the player that is underperforming;
predicting, by the computing system, an impact of the substitution based on historical player information of the proposed substitution;
projecting, by the computing system, a future impact of the substitution on the target team and the substitution over at least one season of play; and
generating, by the computing system, a graphical output reflecting the predicted impact of the substitution and the future impact of the substitution.

11. The method of claim 10, wherein predicting, by the computing system, the impact of the substitution based on the historical player information of the proposed substitution comprises:
identifying a set of players currently in the game for the target team;
identifying in game statistics of each player in the set of players currently in the game; and
replacing the player that is underperforming with the proposed substitution.

12. The method of claim 11, further comprising:
simulating an outcome of the game with the proposed substitution.

13. The method of claim 12, wherein projecting, by the computing system, the future impact of the substitution on the target team and the substitution over the at least one season of play comprises:
projecting the future impact of the substitution on the target team based on the simulated outcome of the game.

14. A system, comprising:
a processor; and
a memory having programming instructions stored thereon, which, when executed by the processor, causes the system to perform operations, comprising:
receiving a pre-game lineup of a team against a target opponent, wherein the pre-game lineup includes a representation of each player starting a game against the target opponent;
retrieving a first set of historical data for each player in the pre-game lineup and team-specific information;
retrieving a second set of historical data for each player of the target opponent and target opponent-specific information;
predicting an outcome for the game based on the first set of historical data and the second set of historical data;
projecting a future effect of the pre-game lineup on at least one season of play by simulating team and player performance; and
generating a graphical output reflecting the predicted outcome of the game and the simulation of team and player performance over the at least one season of play.

15. The system of claim 14, wherein the operations further comprise:
receiving a trade proposal, wherein the trade proposal comprises adding a target player to the team;
retrieving a third set of historical data for the target player;
injecting the target player in the pre-game lineup;
predicting an updated outcome for the game based on the first set of historical data, the second set of historical data, and the third set of historical data; and
projecting an updated future effect of the pre-game lineup with the target player on at least one season of play by simulating team and player performance.

16. The system of claim 15, wherein the operations further comprise:
generating an updated graphical output reflecting the updated predicted outcome of the game and the updated simulation of team and player performance over the at least one season of play.

17. The system of claim 15, wherein predicting the outcome for the game based on the first set of historical data and the second set of historical data comprises:
generating a team strength metric for the team using a first neural network; and
generating a second team strength metric for the second team using a second neural network.

18. The system of claim 17, wherein predicting the outcome for the game based on the first set of historical data and the second set of historical data comprises:
generating role information for each player in the pre-game lineup, using a third neural network, based on the first set of historical data.

19. The system of claim 18, wherein predicting the outcome for the game based on the first set of historical data and the second set of historical data comprises:
identifying recent performance data of the team, a second set of recent performance data of the target opponent, and third set of recent performance data of each player of the team and each player of the target opponent.

20. The system of claim 19, wherein predicting the outcome for the game based on the first set of historical data and the second set of historical data comprises:
predicting the outcome for the game based on one or more of the team strength metric, the second team strength metric, the role information, the recent performance data, the second set of recent performance data, or the third set of recent performance data.
